(19) United States
(12) Patent Application Publication
(10) Pub. No.: US 2005/0060746 A1
(43) Pub. Date: Mar. 17, 2005

(54) Method and apparatus for providing digital television viewer with user-friendly user interface using avatar

(76) Inventor: Beom-eun Kim, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/936,694

(22) Filed: Sep. 9, 2004

(30) Foreign Application Priority Data
Sep. 17, 2003 (KR) 10-2003-0064592

(51) Int. Cl. H04N 7/16; H04N 5/445; G06F 3/00; H04N 7/10; H04N 7/025; H04H 9/00; G06F 13/00

(52) U.S. Cl. 725/46; 725/34; 725/35; 725/45; 725/9

(57) ABSTRACT

Provided are a method and apparatus for providing a digital television viewer with a user-friendly user interface using avatars. The method of providing a user interface using an avatar generates an avatar and a menu screen based on user information collected by a predetermined unit, displays the generated avatar and menu screen, and renews the avatar and the menu screen based on the viewing patterns of a user. The apparatus has an information collection unit for collecting user information such as information input by a user or viewing pattern of the user, an avatar generation and renewal unit for generating and renewing an avatar based on the user information collected by the information collection unit, a menu screen composition unit generating and renewing a menu screen based on the user information collected by the information collection unit, and a data processing unit for transferring the generated or renewed avatar and menu screen to a display. A user receives a user interface including avatars that is for use with a digital television.

This application claims priority from Korean Patent Application No. 10-2003-0064592 filed on Sep. 17, 2003 in the Korean Intellectual Property Office, the disclosure of which is incorporated herein by reference in its entirety.

### BACKGROUND OF THE INVENTION

1. Field of the Invention

The present invention relates to a method and an apparatus for providing a digital television viewer with a user-friendly user interface, and more particularly, to a method and an apparatus for providing a user interface using avatars.

2. Description of the Related Art

With recent advances in digital television technology, the digital television market is now proliferating. As digital television and household digital apparatuses become widespread and more commonly used, household appliances perform not only particular intrinsic functions, but also a variety of functions as a home networking system, and are evolving to an entertainment system providing information to users. Meanwhile, digital television broadcasting offers a large number of channels and hundreds of program options. Thus, there is a need for household appliances such as digital televisions and personal video recorders (PVR) that cater to the preferences of users and provide information based on user preferences in addition to the particular function of providing images. In other words, as the digital age develops, a convenient user interface that is easy for the users to understand and use is increasingly required.

### SUMMARY OF THE INVENTION

The present invention provides a method and an apparatus for providing a digital television viewer with a user-friendly user interface.

According to an aspect of the present invention, there is provided a method for providing a user interface using an avatar, comprising the steps of generating an avatar and a menu screen based on user information, displaying the generated avatar and menu screen, and renewing the avatar and the menu screen based on the viewing pattern of a user.

The user information for the generation of the avatar and the menu screen may include at least one of age, gender, and job, and the generated avatar and menu screen are selected from more than one avatar and menu screen that are displayed based on the user information. The renewing of the avatar and the menu screen may comprise storing viewing pattern information, including but not limited to the genres of programs selected by the user, times that the selected programs are viewed, days on which the selected programs are viewed, duration for which the selected programs are viewed, titles of the selected programs, and viewing channels, and renewing the menu screen based on the stored information. Also, the avatar is preferably renewed when the value of the stored information is over a critical value. The method may further comprise receiving an avatar template for generating and renewing the avatar from an external source through a data communication.

According to another aspect of the present invention, there is provided an apparatus for providing a user interface using an avatar, comprising an information collection unit, an avatar generation and renewal unit, a menu screen composition unit, and a data processing unit.

The avatar generation and renewal unit may include an avatar generation unit for generating and renewing the avatar based on the user information, and an avatar template unit for storing the composition elements of the avatar that are used in generating and renewing the avatar. Also, the apparatus may further comprise a data communication unit for receiving the composition elements of the avatar that are stored in the avatar template unit from external sources. Further, the apparatus may further comprise a storing unit for storing the collected user information and the information of the renewed avatar and menu screen.

### BRIEF DESCRIPTION OF THE DRAWINGS

The above and other features and advantages of the present invention will become more apparent by describing in detail an exemplary embodiment thereof with reference to the attached drawings in which:

FIG. 1 is a block diagram illustrating an apparatus for providing a user interface according to an embodiment of the present invention;

FIG. 2 is a flowchart illustrating a method of providing a user interface according to the embodiment of the present invention;

FIG. 3 is a flowchart illustrating the process of generating avatars of FIG. 2;

FIG. 4 is a flowchart illustrating the process of renewing information of avatars and a menu screen of FIG. 2;

FIG. 5 is a flowchart illustrating the process of renewing an avatar template according to the embodiment of the present invention;

FIG. 6 is a menu screen used to select an avatar from avatars provided in the process of generating avatars according to the embodiment of the present invention; and

FIG. 7 illustrates a menu screen and an avatar renewed based on user information according to the embodiment of the present invention.

### DETAILED DESCRIPTION OF THE PREFERRED EMBODIMENT

The present invention will now be described more fully with reference to the accompanying drawings, in which an exemplary embodiment of the invention is shown.

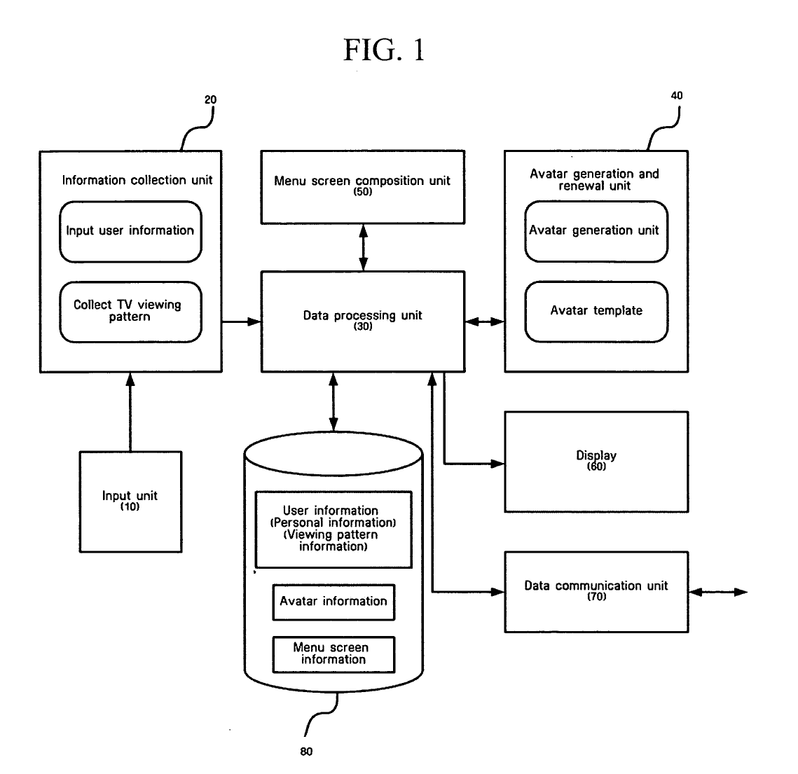

FIG. 1 is a block diagram illustrating an apparatus for providing a user interface according to an embodiment of the present invention.

The apparatus for providing a user interface comprises an information collection unit 20, an avatar generation and renewal unit 40, a menu screen composition unit 50 used to compose a menu screen, a storing unit 80, and a data processing unit 30. Here, the information collection unit 20 collects user information, which is input via an input unit 10. The avatar generation and renewal unit 40 generates and renews avatars based on the collected user information. The storing unit 80 stores the collected user information, the generated and renewed avatars, and menu screen information. The data processing unit 30 exchanges and processes information data among the information collection unit 20, the avatar generation and renewal unit 40, the menu screen composition unit 50, and the storing unit 80. In addition, the apparatus for providing the user interface further comprises a data communication unit 70 for downloading avatar templates from sources external to the apparatus that are used to generate and renew the avatars.

A user may input user information and change or search for channels through the input unit 10. Examples of the input unit 10 include, but are not limited to, a remote controller, a keyboard, and a touch screen. The information collected by the information collection unit 20 comprises user information input by the user and user information such as digital television viewing patterns of the user. Here, the viewing pattern may be the channels, the programs, or the genres of programs frequently selected by the user, or the duration, the time, or the day of viewing a program. The user information input by the user can comprise the gender, age, favorite entertainers, and interests of the user. The information collection unit 20 provides at least one field for receiving the user information, and the user inputs information in each field.

The user information collected by the information collection unit 20 is transferred to the data processing unit 30. The data processing unit 30 transfers the collected user information to the menu screen composition unit 50 to compose a menu screen based on the user information, and to the avatar generation and renewal unit 40 to generate and renew the avatars based on the user information. The generated and renewed avatars, the information of the menu screen, and the collected user information are stored in the storing unit 80. The display 60 is operable to display menu sources, avatars and programs, among other information.

The avatar generation and renewal unit 40 includes an avatar generation unit and an avatar template unit, which is used to generate the avatars. The avatar templates include a figure template having different contours based on gender and age, a face template representing hair styles and eye, nose, and mouth shapes, and a coordinate template representing clothes and accessories. The avatar generation unit uses the avatar templates to generate and renew the avatars based on the user information. For example, one avatar having a female figure in her twenties is generated for a twenty-year-old woman or a plurality of avatars are generated and the woman selects one. New avatar templates may be downloaded from external sources through the data communication unit 70.

The menu screen composition unit 50 composes a menu screen based on the user information. A basic menu screen is provided for a user who generates a new avatar, and the menu screen is renewed according to the viewing pattern of the user.

The avatars generated or renewed in the avatar generation and renewal unit 40, the information of the menu screen generated or renewed in the menu screen composition unit 50, and the user information collected by the information collection unit 20 are stored in the storing unit 80. The user information includes the personal information and the viewing pattern information of the user. On the other hand, when a digital television is used by a plurality of users, characteristic user information for each user is stored, and avatars and menu screens corresponding to the user information are constructed accordingly.

Renewal of the avatar and the menu screen may be performed whenever the user information is changed; however, it is preferred that the avatar and the menu screen are changed when predetermined fields of the user information exceed critical values. For example, when the viewing ratio of a sports genre is over 40% in a given week, the clothes or hair style of the avatar is preferably renewed to a sports look.

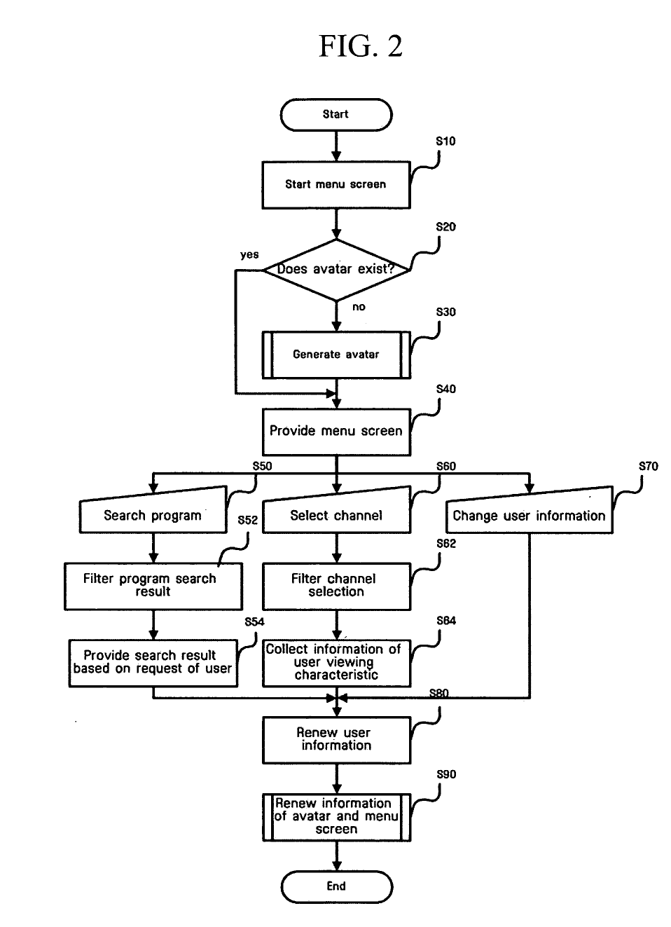

FIG. 2 is a flowchart illustrating a method of providing a user interface according to the embodiment of the present invention.

In the method, a menu screen is started in step S10. The menu screen may be started by turning on a digital television or by selecting the menu screen through an input unit, such as a remote controller.

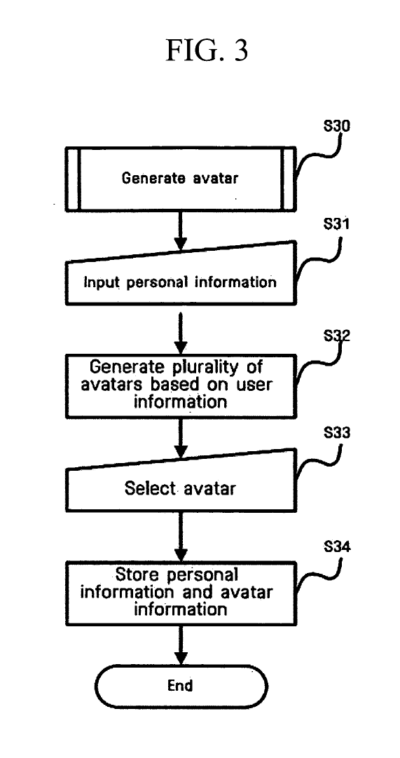

When it is determined in step S20 that an avatar of a user is absent after the menu screen is started, an avatar is generated in step S30. The process of generating an avatar will later be described with reference to FIG. 3.

When the avatar for a user is generated, a menu screen with the avatar is provided to the user in step S40.

The user may select channels and search programs by using the menu screen. The user may search the programs based on his or her taste. The scope of the present invention is not limited to a search based on the titles of the programs; however, the user may search the programs by the names of actors or actresses or by genres of programs.

In the process of searching programs, the user inputs a search word to search the programs in step S50. The search result may be filtered, that is, provided to the users under certain restrictions in step S52. For example, adult programs included in the search result are not provided to users under a certain age. Accordingly, the search result is provided after a filtering process in step S54. For example, when the user searches the programs for the name of a popular entertainer, such as Hee-Seon Kim, the programs in which she appears are provided as the search result. However, the search result is filtering processed, thus adult programs included in the search result are not provided to underage users.

In the process of searching channels, the user selects a desired channel in step S60. A filtering process is also included in the channel search process in step S62. In other words, underage users cannot select adult channels. When the user views programs provided after the filtering process in step S62, information of the viewing pattern of the user, for example, the viewing time, the viewing day, and the genres of the programs, is collected in step S64. According to the present invention, in step S62, some channels may not be selected according to user's age or other conditions.

The filtering processes in steps S52 and S62 in the searching and the selection of the programs may be performed based on the age of the user; however, the filtering process may be performed based on the right to view the channel or the program. For example, when the channels include subscription and pay-per-view channels, only a user whose user information includes payment information related to or viewing rights of the charged channels can select or search the charged channels.

The user may change his or her user information whenever he or she purchases viewing rights or changes interests, in step S70.

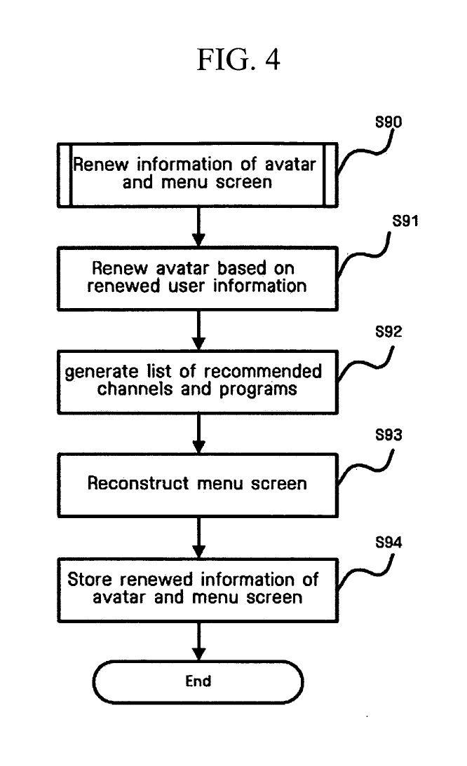

The user information is renewed based on the user information collected by the program search, the channel selection, and the change of the user information, in step S80. Then, the avatar and the information of the menu screen are renewed in step S90. The process of renewing the avatar and the information of the menu screen will later be described with reference to FIG. 4.

FIG. 3 is a flowchart illustrating the avatar generation process of FIG. 2.

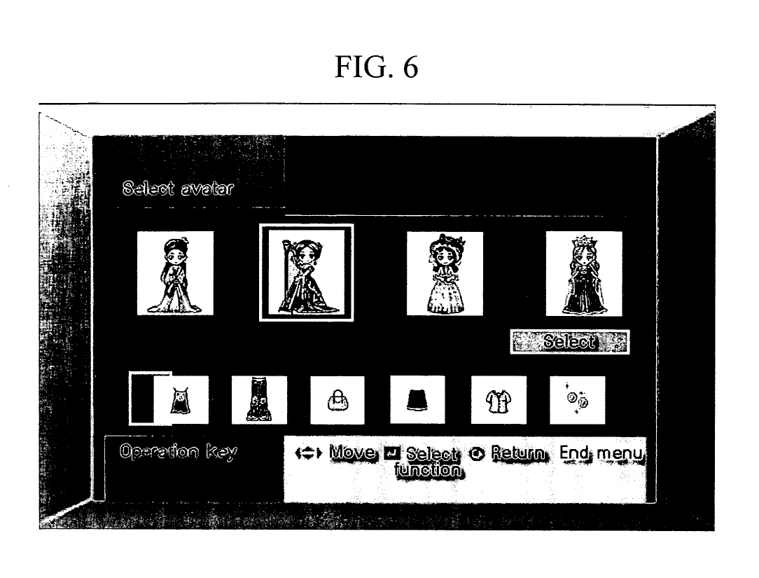

In order to generate an avatar, a user inputs personal information in step S31. Based on the input personal information, one or more avatars are generated by combining avatar templates, in step S32. When a plurality of avatars are generated as shown in FIG. 6, the user selects one avatar in step S33. When the user selects the avatar, the personal information and the selected avatar information are stored in step S34.

FIG. 4 is a flowchart illustrating the avatar and the information of the menu screen renewal process of FIG. 2.

An avatar is renewed based on renewed user information in step S91. For example, when 40% of the programs the user views in one week are of a sports genre, the clothes of the avatar may be changed into a sports look, or the clothes of the avatar may be changed according to the season. After the avatar is renewed, a list of recommended channels and programs is generated in step S92. The list of the recommended channels and programs may be generated based on the programs, channels, or genres of programs most frequently viewed the week before. However, when an algorithm recommending programs to the user is used, the recommendation list may be generated based on the viewing pattern of the user.

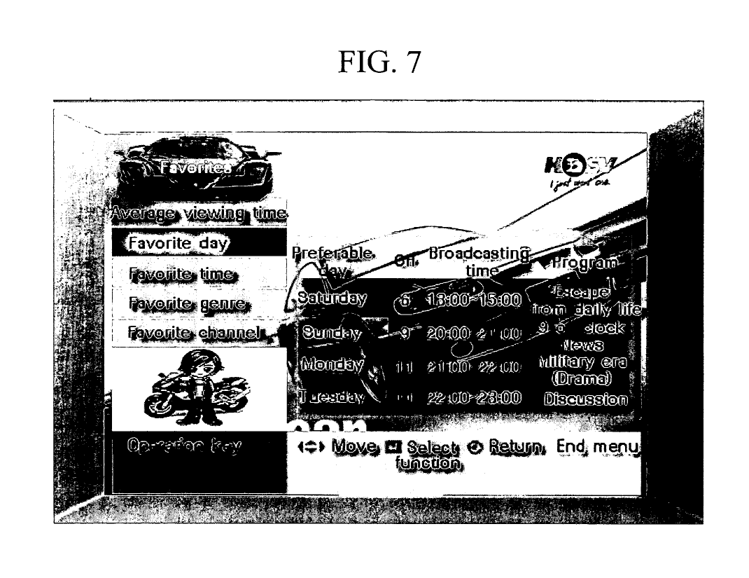

Then, the menu screen is reconstructed in step S93. That is, the menu screen may be constructed according to viewing pattern of the user, for example, by generating a program list including programs that have been viewed for over 30 minutes, programs frequently viewed on a daily basis, programs of frequent viewing times, programs of favorite programs genres, and programs of favorite channels. The menu screen renewed by the user information and the avatar is shown in FIG. 7. Then, the renewed avatar and information of menu screen are stored in step S94.

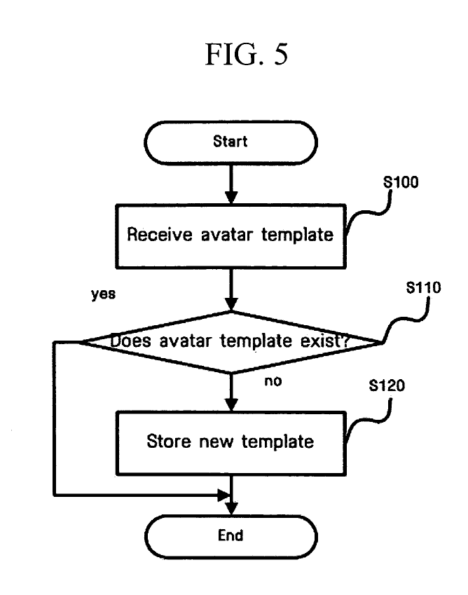

FIG. 5 is a flowchart illustrating a process of renewing an avatar template according to the embodiment of the present invention.

First, an avatar template is received from an external server through the Internet or the wireless Internet, in step S100. It is determined whether the received avatar template currently exists in the storing unit 80 in step S110. When the received template does not exist there, the received avatar template is stored in step S120. Otherwise, the process is ended.

According to the present invention, a viewer of digital television broadcasting may use an interface including an avatar. The user may watch the growth of the avatar and receive a menu screen based on the viewing patterns of the user. On the other hand, the avatar may be upgraded by downloading new avatar templates from the outside through the Internet.

In concluding the detailed description, those skilled in the art will appreciate that many variations and modifications can be made to the preferred embodiments without substantially departing from the principles of the present invention. Therefore, the disclosed preferred embodiments of the invention are used in a generic and descriptive sense only and not for purposes of limitation.

1. A method of providing a user interface using an avatar, the method comprising:
generating an avatar and a menu screen based on user information collected by a predetermined unit;
displaying the generated avatar and menu screen; and
renewing the avatar and the menu screen based on the viewing patterns of a user.

2. The method of claim 1, wherein the user information in the generating of the avatar and the menu screen includes at least one of age, gender, and job, and the generated avatar and menu screen are selected from more than one avatar and menu screen that are displayed based on the user information.

3. The method of claim 1, wherein the renewing step comprises storing viewing pattern information, comprising at least one of the genres of programs selected by the user, times that the selected programs are viewed, days on which the selected programs are viewed, duration for which the selected programs are viewed, titles of the selected programs, and viewing channels, and renewing the menu screen based on the stored information in the renewing of the avatar and the menu screen.

4. The method of claim 1, wherein the renewing of the avatar and the menu screen comprises storing viewing pattern information comprising at least one of the genres of programs selected by the user, times that the selected programs are viewed, days on which the selected programs are viewed, duration for which the selected programs are viewed, titles of the selected programs, and viewing channels, and renewing the avatar when the value of the stored information is over a critical value.

5. The method of claim 1, further comprising receiving an avatar template for generating and renewing the avatar from an external source through a data communication link.

6. The method of claim 1, further comprising restricting services, including selecting channels or searching programs, based on the collected user information.

7. An apparatus for providing a user interface using an avatar, the apparatus comprising:
an information collection unit for collecting user information including information input by a user or viewing pattern of the user;
an avatar generation and renewal unit for generating and renewing an avatar based on the user information collected by the information collection unit;
a menu screen composition unit for generating and renewing a menu screen based on the user information collected by the information collection unit; and
a data process unit for transferring the generated or renewed avatar and menu screen to a display.

8. The apparatus of claim 7, wherein the avatar generation and renewal unit comprises:
an avatar generation unit for generating and renewing the avatar based on the user information;
and an avatar template unit for storing the composition elements of the avatar that are used in generating and renewing the avatar.

9. The apparatus of claim 8, further comprising a data communication unit for receiving the composition elements of the avatar that are stored in the avatar template unit from external source.

10. The apparatus of claim 7, further comprising a storing unit for storing the collected user information and the information of the renewed avatar and menu screen.

11. The apparatus of claim 7, further comprising a storing unit for storing user information of each of a plurality of users and avatars and menu screens based on the user information of the users.
